(19) United States
(12) Patent Application Publication
(10) Pub. No.: US 2004/0219498 A1
(43) Pub. Date: Nov. 4, 2004

(54) Training apparatus and methods

(76) Inventor: Lance Samuel Davidson, Scottsdale, AZ (US)

Correspondence Address: Michael W. Goltry, PARSONS & GOLTRY, Suite 260, 340 East Palm Lane, Phoenix, AZ, 85004, US

(21) Appl. No.: 10/410,082

(22) Filed: Apr. 9, 2003

Related U.S. Application Data
(60) Provisional application No. 60/370,595, filed on Apr. 9, 2002.

(51) Int. Cl. A63B 69/00; G09B 9/00; G09B 19/00

(52) U.S. Cl. 434/247; 482/1

(57) ABSTRACT

Disclosed is a training system consisting of storage maintaining a reference body movement model, and a system for collecting a trainee body movement model. A computer is associated with the storage and the system, which compares the trainee body movement model to the reference body movement model and generates a report comparing the trainee body movement model to the reference body movement model. The report includes an identification of similarity between the trainee body movement model and the reference body movement model, and an identification of dissimilarity between the trainee body movement model and the reference body movement model.

### CROSS-REFERENCE TO RELATED APPLICATIONS

This application claims the benefit of Provisional Application Serial No. 60/370,595, filed Apr. 9, 2002.

### FIELD OF THE INVENTION

This invention relates to advanced training systems and methods.

### BACKGROUND OF THE INVENTION

The role of a coach is to enable the athlete to achieve levels of performance that may not be possible if the athlete is left to his own endeavors. A wise coach develops not only the fullest physical potential in his charges, but also those capacities and habits of mind and body which will enrich and ennoble their later years. Effective training in a particular activity, whether golf, skiing, fly-fishing, cycling, running, swimming, and batting, to name but only a few of many types of physical activities, requires repetition, mental focus, dedication, perseverance, and a judicious and experienced coach for supplying the student with the necessary instruction, tools, motivation, and experience for helping the student achieve his/her maximum potential. Not everyone has access to a coach. As a result, many inherently talented people throughout the world fail to reach their full potential in their chosen activities.

Thus, there is a need in the art for advanced training systems and methods that are efficient and reliable. Another object of the invention is to provide improved training systems and methods that do not require a coach. Still a further provision of the invention is to provide improved training systems and methods that exploit the advancements in computer technology and systems and methods for tracking body movement.

### SUMMARY OF THE INVENTION

The above problems and others are at least partially solved and the above purposes and others realized in new and improved training system and method embodiments. A first apparatus embodiment consists of storage maintaining a reference body movement model, and a system for collecting a trainee body movement model. A computer is associated with the storage and the system, and is operative for comparing the trainee body movement model to the reference body movement model and generating a report comparing the trainee body movement model to the reference body movement model. The report includes an identification of similarity between the trainee body movement model and the reference body movement model. The report can also include an identification of dissimilarity between the trainee body movement model and the reference body movement model. The report can still further include remedial instructional information explaining how to correct the trainee body movement model to conform substantially to the reference body movement model.

Another apparatus embodiment consists of a first system for collecting a reference body movement model, a second system for collecting a trainee body movement model, and a computer associated with the first system and the second system for comparing the trainee body movement model to the reference body movement model and generating a report comparing the trainee body movement model to the reference body movement model. The report includes an identification of similarity between the trainee body movement model and the reference body movement model. The report can also include an identification of dissimilarity between the trainee body movement model and the reference body movement model. The report can still further include remedial instructional information explaining how to correct the trainee body movement model to conform substantially to the reference body movement model.

Yet another apparatus embodiment consists of storage maintaining a database of reference body movement models, a trainee body movement model collection system, and a computer. The computer is associated with the storage and the trainee body movement model collection system and is operative for comparing a trainee body movement model collected by the trainee body movement model collection system to a designated one of the reference body movement models and generating a report comparing the trainee body movement model to the designated one of the reference body movement models. The report compares the trainee body movement model to the designated one of the reference body movement models and includes an identification of similarity between the trainee body movement model and the designated one of the reference body movement models. In another embodiment, the report compares the trainee body movement model to the designated one of the reference body movement models and includes an identification of dissimilarity between the trainee body movement model and the designated one of the reference body movement models. In yet another embodiment, the report compares the trainee body movement model to the designated one of the reference body movement models and includes remedial instructional information explaining how to correct the trainee body movement model to conform substantially to the designated one of the reference body movement models.

Still another apparatus embodiment consists of storage maintaining a database of reference body movement models, a trainee body movement model collection system, and a computer. The computer is associated with the storage and the trainee body movement model collection system, and is operative for comparing a trainee body movement model collected by the trainee body movement model collection system to designated ones of the reference body movement models and generating a report comparing the trainee body movement model to each of the designated ones of the reference body movement models. In one embodiment, the report compares the trainee body movement model to each of the designated ones of the reference body movement models includes and includes an identification of similarity between the trainee body movement model and each of the designated ones of the reference body movement models. In another embodiment, the report compares the trainee body movement model to each of the designated ones of the reference body movement models and includes an identification of dissimilarity between the trainee body movement model and each of the designated ones of the reference body movement models. In yet another embodiment, the report compares the trainee body movement model to each of the designated ones of the reference body movement models and includes remedial instructional information explaining how to correct the trainee body movement model to conform substantially to each of the designated ones of the reference body movement models.

Yet still another apparatus embodiment consists of storage maintaining a reference body movement model indicative of movement of reference points in space, in which each of the reference points defines a predetermined reference movement path. Also provided is a system for generating a trainee body movement model indicative of movement of trainee reference points in space, in which each of the trainee reference points defines a trainee movement path corresponding to one of the reference movement paths. This embodiment incorporates alarms, which are each associated with one of the trainee reference points, and a computer. The computer compares the reference movement paths of the reference points of the reference body movement model to the trainee movement paths of the trainee reference points of the trainee body movement model, and for each trainee reference point activates its corresponding alarm if the trainee movement path thereof does not sufficiently correspond to, or otherwise fall within an acceptable range relating to, the reference movement path of the corresponding reference point of the reference body movement model. In a particular embodiment, the invention incorporates a close fitting garment, in which the trainee reference points are defined by sensors carried by the close fitting garment, and the alarms are each associated with one of the sensors. Each of the alarms when activated issues an alerting stimulus, such as least one of an audible stimulus, a visual stimulus, and a physical stimulus such as a vibrating stimulus.

A further apparatus embodiment consists of storage maintaining a reference body movement model indicative of movement of reference points in space, in which each of the reference points defines a predetermined reference movement path. There is also a system for generating a trainee body movement model indicative of movement of trainee reference points in space, in which each of the trainee reference points defines a trainee movement path corresponding to one of the reference movement paths. Robotic mechanisms, carried by a close fitting garment, are each associated with one of the trainee reference points. A computer is also provided for comparing the reference movement paths of the reference points of the reference body movement model to the trainee movement paths of the trainee reference points of the trainee body movement model, and for each trainee reference point activating its corresponding robotic mechanism to promote corrective movement to the close-fitting garment if the trainee movement path thereof does not sufficiently correspond to, or otherwise fall within an acceptable range relating to, the reference movement path of the corresponding reference point of the reference body movement model.

Consistent with the foregoing, the invention also contemplates associated apparatus and method embodiments.

### BRIEF DESCRIPTION OF THE DRAWINGS

Referring to the drawings:

FIG. 1 is a schematic representation of system for tracking body movements including a computer linked to a trainer garment and a trainee garment, in accordance with the principle of the invention;

FIG. 2 is another schematic representation of the system of FIG. 1;

FIG. 3 is a perspective view of the trainee garment of FIG. 1 shown worn as it would appear in use, in which the trainer garment is substantially identical to the trainee garment;

FIG. 4 is a perspective view of the trainee garment of FIG. 1 shown worn by a trainee holding a fishing pole by hand;

FIG. 5 is an enlarged fragmented perspective view of a tip of the fishing pole of FIG. 3 incorporating a sensor;

FIG. 6 is a fragmented perspective view of a portion of the trainee movement tracking garment of FIG. 1 illustrating a sensor and an alarm;

FIG. 7 is a perspective view of a golf club furnished with a sensor for use with the system of FIG. 1;

FIG. 8 is a perspective view of a ring furnished with a sensor for use with the system of FIG. 1;

FIG. 9 is a perspective view of a glove furnished with sensors for use with the system of FIG. 1;

FIG. 10 is a perspective view of a booty furnished with sensors for use with the system of FIG. 1;

FIG. 11 is a perspective view of a hood furnished with sensors for use with the system of FIG. 1; and

FIG. 12 is a fragmented perspective view of a portion of the trainee movement tracking garment of FIG. 1 illustrating a robotic mechanism associated therewith.

### DETAILED DESCRIPTION OF PREFERRED EMBODIMENTS

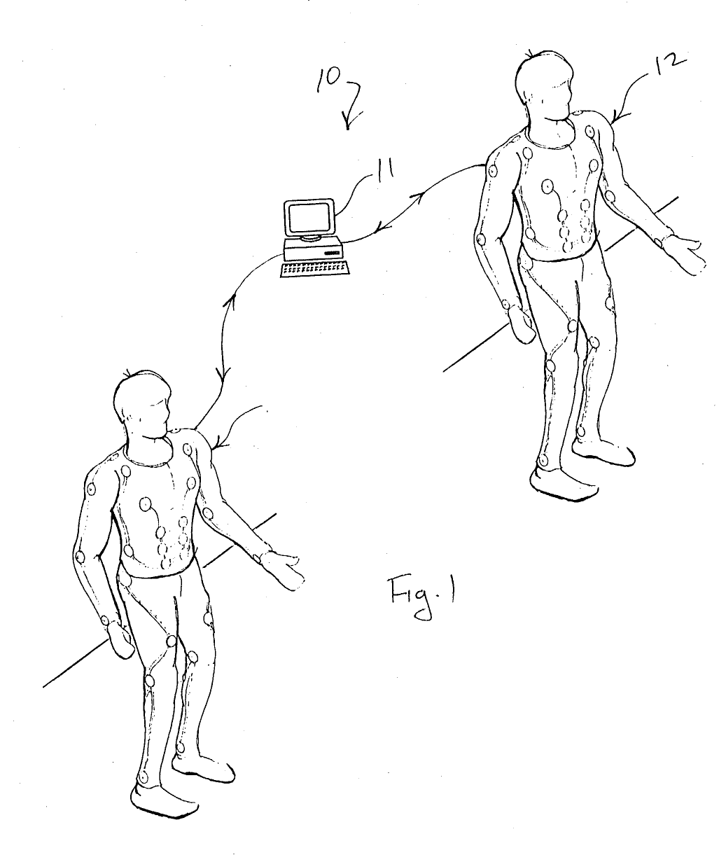

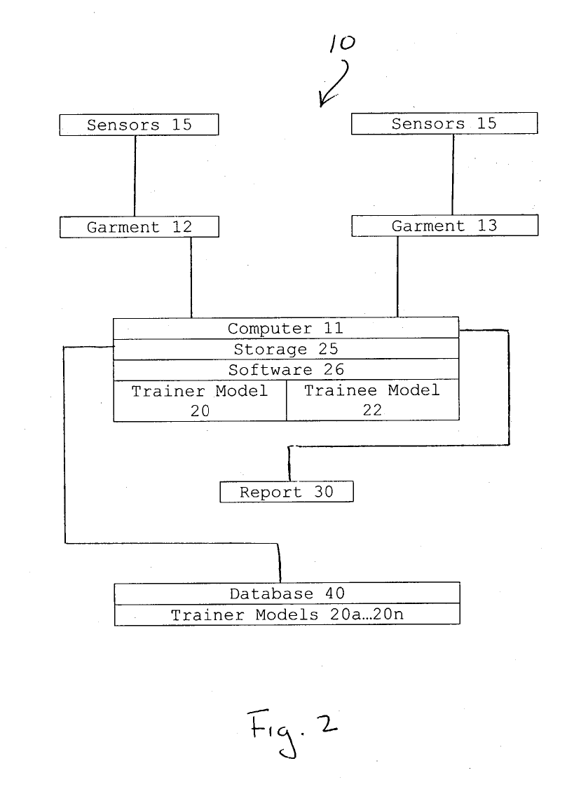

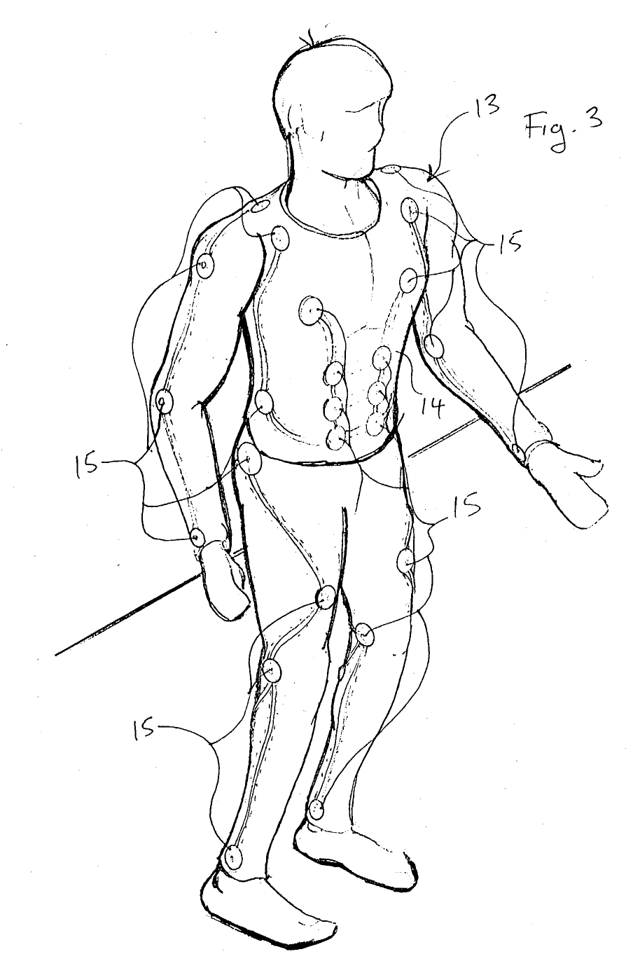

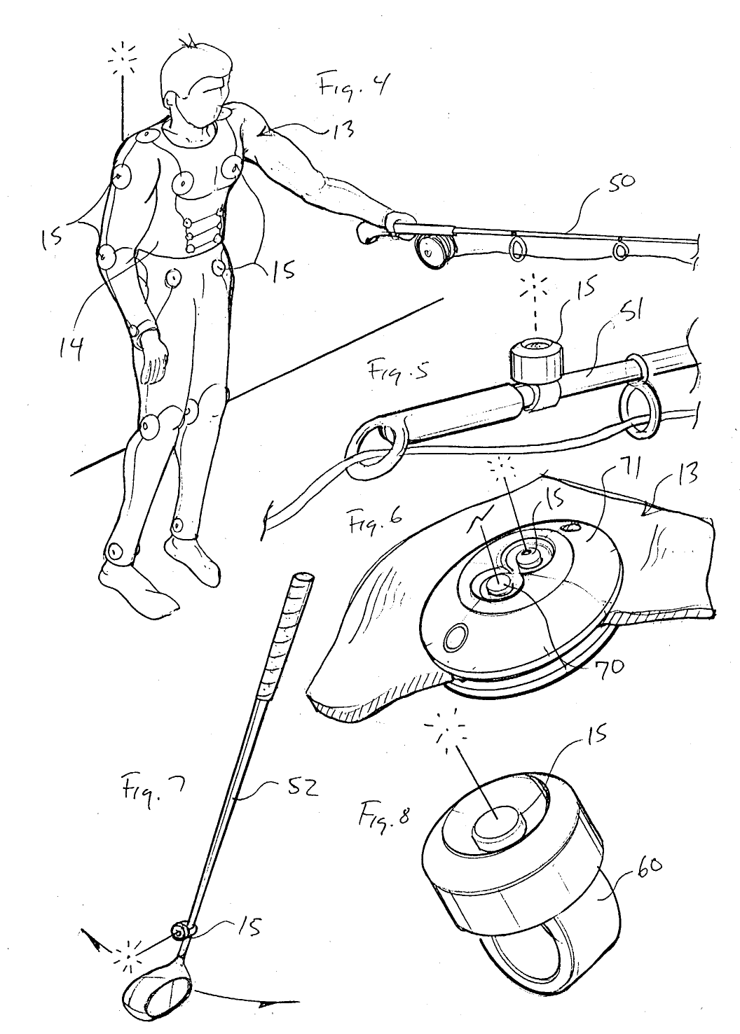

Turning now to the drawings, in which like reference characters indicate corresponding elements throughout the several views, attention is first directed to FIG. 1, in which is seen a schematic representation of system 10 for tracking body movements including a computer 11 linked to a trainer garment 12 and a trainee garment 13, in accordance with the principle of the invention. System 10 accurately tracks body movements of users wearing garments 12,13, and particularly subtle body articulations, and generates data indicative of the movements, which is integrated into computer 11. Garment 13 is shown in more detail in FIG. 3, and consists of a close-fitting garment 14 that supports sensors, which are each denoted generally at 15. Sensors 15 are functional for determining the position and orientation of the wearer in space, for monitoring flexure of the articulations of the wearer, and for determining when the wearer is walking, standing, running, etc. Movement by the wearer of garment 13 generates data indicative of the movement for manipulation by and for manipulating a program running on computer 11. To the extent so far described, it is to be understood that garment 12 is substantially identical to garment 13, and that the foregoing discussion of garment 13 applies to garment 12. Sensors 15 are coupled to computer 11 in data communication, and this data communication coupling can be made in any conventional manner, whether by conventional wired and/ore wireless interconnections, in which wireless interconnections are preferred as a matter of reducing unwieldy wiring.

Set forth for purposes of orientation and reference in connection with the ensuing detailed description of the preferred embodiment of the instant invention, the foregoing brief description of system 10 is intended to be generally representative of a typical system operable for tracking body movements and for generating data indicative of body movements. Many such systems for tracking body movement are known in the art, such as that set forth in U.S. Pat. No. 5,963,891 (the '891 patent). System 10, including computer 11 and garments 12,13, may be constructed and arranged in accordance with the teachings set forth in the '891 patent. Details not specifically illustrated and described will be readily understood and appreciated by those skilled in the art.

Computer 11 has processing apparatus, an associated output apparatus such as a monitor or display, and input apparatus such as a keyboard, a pointing device, etc. Computer 11 can also be associated with a printer, a scanner, a camera, etc. Computer 11 is furnished or otherwise associated with storage 25. Storage 25 is resident or local storage and preferably resident and houses, among other things, software 26 of system 10. Storage 25 can house other things, such as a commercially available browser application 24 for facilitating access to and communication with a computer network such as a local area network or the Internet, and an operating system or platform and preferably one that is multi-tasking and responsive to inputs for accessing and interacting with storage and with networked components.

Sensors 15 define reference points in space, in which each of the reference points defines a predetermined reference movement path. In reference to garment 12, the sensors 15 thereof define trainer reference points in space in which each of the trainer reference points defines a trainer reference movement path. In reference to garment 13, the sensors 15 thereof define trainee reference points in space in which each of the trainee reference points defines a trainee reference movement path.

In the use of system 10, garment 12 is to be worn by a trainer or coach, and garment 13 is to be worn by a trainee or student, whether at the same time or at different times. With reference to FIG. 2, the trainer initiates movement, and garment 12 tracks the body movement of the trainer wearing garment 12 during the course of the movement and generates data commensurate with the tracked body movements and stores the data as a trainer reference body movement model 20 (hereinafter “trainer model 20”) in storage 25 maintained by or otherwise associated with computer 11. Trainer model 20 is a particular type of movement of the trainer, such as a golf swing, a tennis swing, a fly-fishing cast, a batting swing, a discuss throw, a shot-put throw, a rowing stroke, a dance movement, dance movements, a dance, etc. Computer 11 is programmed by way of software 26 to acquire trainer model 20 and store model 20 into storage 25. Trainer model 20 is indicative of the trainer reference movement paths of the trainer reference points, namely, sensors 15 of garment 12.

The trainee initiates movement, and garment 13 tracks the body movement of the trainee wearing garment 13 during the course of the movement, and generates data commensurate with the tracked body movements and stores the data as a trainee reference body movement model 22 (hereinafter “trainee model 22”) in storage 25 maintained by or otherwise associated with computer 11. Like model 20, model 22 is a particular type of movement of the trainee, such as a golf swing, a tennis swing, a fly-fishing cast, a batting swing, a discuss throw, a shot-put throw, a rowing stroke, a dance movement, dance movements, a dance, etc. Computer 11 is programmed to acquire trainee model 22 and store trainee model 22 into storage 25. Trainee model 22 is indicative of the trainee reference movement paths of the trainee reference points, namely, sensors 15 of garment 13.

In accordance with the invention, the type of movement indicative of trainee model 20 is the same as trainer model 22. Trainer model 22 is a proper, recommended, or correct movement of a particular type of movement, or, perhaps, a desired movement of a type of movement that a trainee wishes to learn or emulate. After acquiring trainee model 22, computer 11 is responsive, either automatically or manually in response to input user commands and in accordance with programming provided by software 25, and compares trainee model 22 to trainer model 20 and generates a report 30 comparing trainee model 22 trainer model 22. Although only one report is generated, a plurality of reports can be generated if desired. Report 30 includes an identification of similarity between trainee model 22 and trainer model 22 and, in addition thereto or optionally, an identification of dissimilarity between trainee model 22 and trainer model 20, e.g., whether the trainee movement paths of the trainee model 22 correspond to, or otherwise fall within an acceptable range relating to, the trainer movement paths of trainer model 20. Report 30 can be accessed by computer 11 as an electronic document and printed from a printer associated with computer 11. After report 30 is generated, it can be stored, either automatically or manually, in storage 25 or elsewhere for later use. Preferably, report 30 includes remedial instructional information explaining how to correct trainee model 22 to conform substantially to trainer model 20, of which a trainee can use for taking corrective action. The positioning of sensors 15 of garments 12,13 is substantially identical, so comparisons of trainee and trainer movement models can be accurately made. Typically, report 30 will identify which, if any, of the trainee movement paths correspond to, or otherwise fall within an acceptable or predetermined range relating to, the trainer movement paths of trainer model 20 (such as within 2%, 5%, 10%, etc., of each of the trainer reference movement paths), and which, if any, of the trainee movement paths that do not correspond to, or otherwise fall within an acceptable or predetermined range relating to, the trainer movement paths (such as within 2%, 5%, 10%, etc., of each of the trainer reference movement paths). In this way, an accurate identification of particular problem movement paths in the trainee model 22 can be readily identified.

Report 30 is to be used by the trainee in examining the similarities and differences between his trainee model 22 and trainer model 22, which allows the trainee to understand how to correct his movement for the purpose of helping him conform his movement to correspond substantially to, or otherwise fall within an acceptable range relating to, or otherwise more closely resemble the movement embodied by, trainer model 22. After examining report 30, system 10 can again be used by the trainee to collect a new trainee model, in which a new report is generated comparing the new trainee model to trainer model 20. This process can be repeated by a trainee as many times as necessary for the trainee to effectively train himself to engage in a specific type of movement that conforms substantially to trainer model 20 as provided by the trainer.

A trainee and trainer can use system 10 at the same time, if desired, or at different times. In using system 10 at the same time, the trainer can, for instance, engage in repeated golf swings (or other selected type of movement) for creating repeated trainer models of golf swings, and a trainee can, in accordance with instructions provided by the trainer, engage in repeated golf swings for creating repeated trainee models, in which the trainee models are compared by computer 11 to the trainer models to generate reports useful for teaching the trainee to alter his swing or otherwise correct his swing to better conform with the collected trainer models. In using system 10 at different times, trainer model 20 is stored in storage 25, and accessed by a trainee via computer 11 for comparing collected trainee models to stored trainer model 20.

Although only one trainer model 20 is discussed as stored storage 25, a potentially vast number of stored trainer models 20a-20n can be provided and, for instance, maintained in a database 40 of storage 25, in which a trainee can use computer 11 to browse through trainer models 20a-20n of database 40 and make desired selections of trainer models in the use of system 10 as previously explained. Stored trainer models can each be different from one another, and can represent movements by different trainers. For instance, stored trainer models can be 1)different golf swings from the same or different trainers (such as golf coaches or professional golfers), 2)different tennis swings from the same or different trainers (such as tennis coaches or professional tennis players), 3)different batting swings from the same or different trainers (such as batting coaches or professional baseball players), etc., to name but a few. In this respect, database 40 can include activity- or subject-specific categories each containing one or more trainer models for a trainer to select from. The activity- or subject-specific categories and/or trainer models can also include identifications of the trainers from whence the trainer models came.

Rather than incorporating sensors 15 with garments 12,13, sensors 15 can be directly attached to a trainer in the course of use of system 10, and can be directly attached to a trainee in the course of use of system 10. Still, the positioning of sensors to a trainer and a trainee should be substantially identical in order to facilitate accurate comparisons by computer 11 between trainer and trainee models, and between the trainee and trainer reference points. Sensors 15 can be attached to trainees and trainers by way of any desired means. In accordance with the preferred embodiment disclosed herein, garments 12,13 function as carriers for sensors 15. One or more other types of carriers can be used without departing from the invention.

Some activities incorporate the use of implements. For instance, golfing incorporates the use of golf clubs, fly-fishing incorporates the use of a fly rod and line, tennis incorporates the use of a tennis club, etc. In this respect, one or more sensors for use by the trainer can by attached to an implement used by the trainer in the course of the creation of a trainer model so as to track movement of the implement, and this also is true for creation of a corresponding trainee model. To illustrate this point, reference is directed to FIGS. 4, 6 and 7. FIG. 4 illustrates a trainee wearing garment 13, in which the trainee is holding a fly rod 50. FIG. 5 shows a tip 51 of fly rod 50 with a sensor 15 attached thereto for use with system 10. Although fly rod 50 is depicted with only one attached sensor 15, more can be provided at selected positions, if desired. One or more sensors can also be disposed on a fishing line of fly rod so as to track movement of the fly line, and this aspect can be incorporated with a trainer model and for use by a trainee. This can be particularly useful for helping a trainee understand the nature of fly-casting by giving the trainee feedback of how his fly line is translating through space during a casting stroke as compared to the way a fly line is translating through space in a trainer model. A proper fly-casting stroke is often best understood by analyzing the movement of the fly line in space in response to a casting stroke, and so the invention can be particularly useful for teaching trainees the subtleties of fly-casting. The invention can be used with other types of fishing poles.

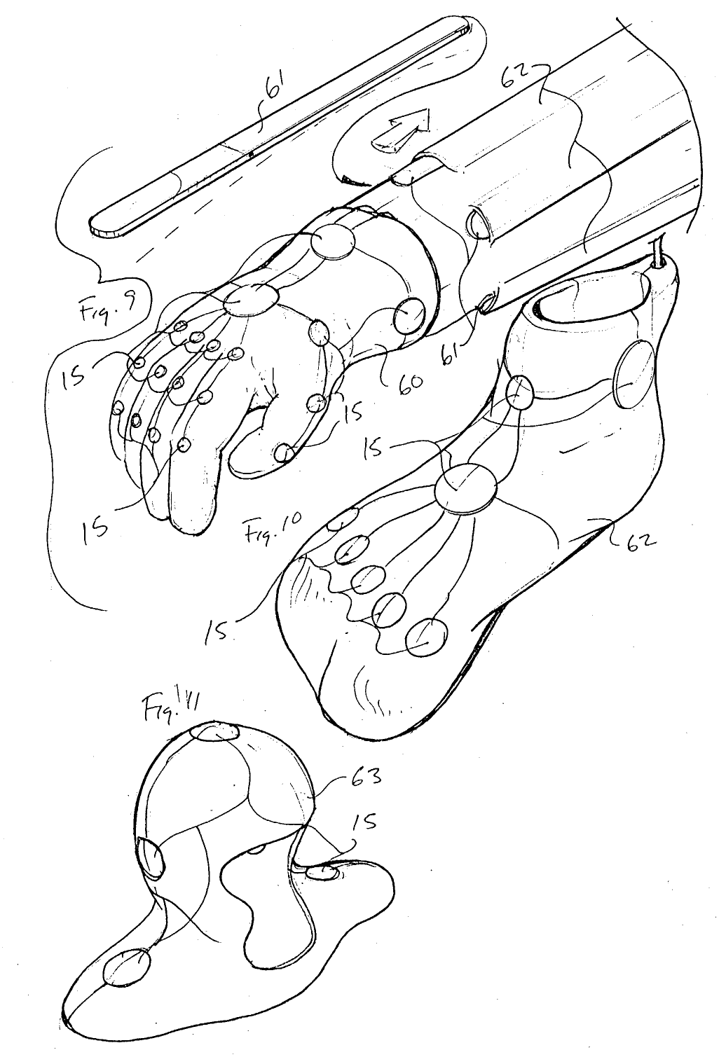

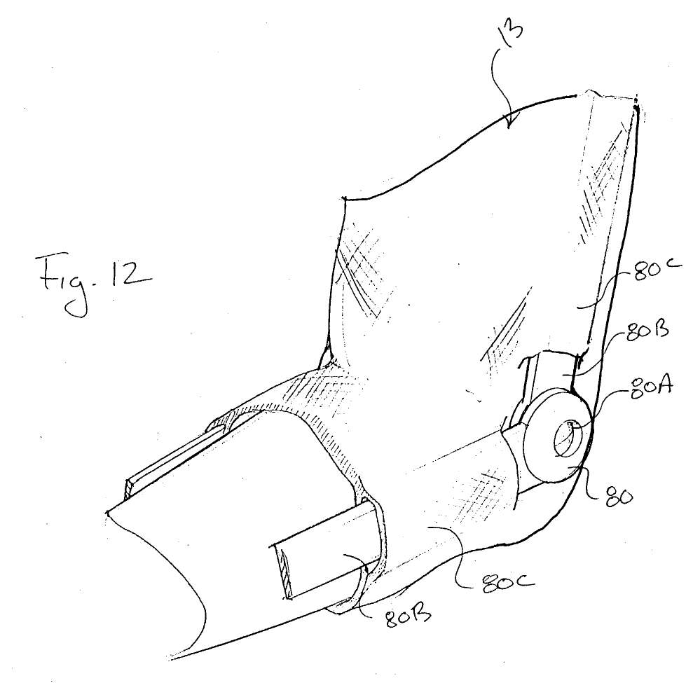

FIG. 7 is a perspective view of golf club 52 having an attached sensor 15 for use with system 10. Although golf club 52 is depicted with only one attached sensor 15, more can be provided at selected positions, if desired. One or more sensors 15 for use with system 10 can be incorporated with other items, such as a ring 60 to be worn on a finger as set forth in FIG. 8, a glove 61 to be worn by hand as set forth in FIG. 9, a shoe or booty 62 to be worn by foot as set forth in FIG. 10, a hat or head covering 63 as set forth in FIG. 11, etc. Other implements and articles can incorporate one or more sensors for use with system 10, as desired. As shown in FIG. 9, disclosed are support spines 61, which are received in sleeves 62 of close-fitting garment 14 for provided added support to garment 14. The provision of splines 61 is an option feature for introducing a certain amount of support or rigidity to close-fitting garment 14. Garment 12 may also be provided with such splines, if desired.

FIG. 6 is a fragmented perspective view of a portion of garment 13 illustrating a sensor and, in accordance with the invention, an alarm 70, which, in this embodiment, are carried by an attached base 71 of garment 13. Alarm 70 and its corresponding sensor 15 can be attached to garment 13 in many ways and even directly to a trainee, if desired, and as intimated earlier in this specification. When activated, alarm 70 issues an alerting stimulus, such as an audible stimulus, a visual stimulus (such as a flashing light), and/or a physical stimulus such as a vibrating stimulus, an electrical shock or other applied force to be felt by a trainee wearing garment 13, etc. Alarm 70 can be made to issue any desired alerting stimulus. Alarm 70 is associated with sensor 15 in FIG. 6, and is therefore associated with the trainee reference movement path provided by the trainee reference point thereof. In a particular embodiment, alarms 70 are each associated with one of the trainee reference points of garment 13, namely, sensors 15 thereof. In a comparing event carried out by computer 11 as herein described wherein a trainee model is compared to a trainer model, the comparing event is carried out by computer 11 in real time, in which the trainee model is generated in real time as the trainee initiates a selected movement and is compared real time to trainer model 20 maintained by storage 25. This real time comparison can be initiated manually, or, in accordance with programming provided by software 26, automatically by computer 11 in response to a trainee initiating a selected movement.

In this embodiment, computer 11 compares the trainer reference movement paths of the trainer reference points of trainer model 20 to the trainee reference movement paths of the trainee reference points of the trainee model during the course of its acquisition. Computer 11 is responsive to this real-time comparison event, and for each trainee reference point activates its corresponding alarm 70 if the trainee reference movement path thereof does not sufficiently correspond to, or otherwise fall within an acceptable or predetermined range relating to, the trainer reference movement path of the corresponding trainer reference point of trainer model 20. When an alarm activates, it indicates to the trainee that the trainee reference point for which it corresponds is outside the corresponding trainer reference movement path of trainer model 20, or otherwise outside of an acceptable or predetermined range or tolerance (such as 2%, 5%, 10%, etc., of the specified trainer reference movement path) of the trainer reference movement path of trainer model 20. This embodiment provides the trainee with immediate feedback as to the competency of the trainee movement paths as compared to the trainer movement paths of the trainer model 20 during the course of the trainee movement. This aspect of the invention need not take place in a real time comparison event. In other words, a trainee model can be acquired after a trainee initiates a movement or swing and then compared to a trainer model, after which one or more of the alarms will activate indicating to the trainee which trainee movement paths as defined by the trainee reference points failed to adequately correspond to, or otherwise fall within an acceptable range relating to, the corresponding trainer movement paths of the trainer reference points of the trainer model. Report 30 can also be generated along with the use of alarms as herein described.

FIG. 12 is a fragmented perspective view of a portion of garment 13 illustrating a robotic mechanism 80 associated therewith, namely, an arm portion of garment 13. Robotic mechanism 80 is depicted generally, an actuator 80A coupled to arms 80B that extend into sleeves 80C of garment 13. Actuator 80A is actuated by computer 11 so as to impart movement to arms 80B. Robotic mechanism 80 is conventional and disclosed as a matter of example, and is a mechanical device that is capable of performing a variety of functions and is operated by computer 11. Robotic mechanism 80 is of any conventional type, of which many are known and useful with the invention, that computer 11 controls and activates. When robotic mechanism 80 activates, it is made to impart movement to garment 13 or otherwise inhibiting movement of garment 13. Although FIG. 12 illustrates only a portion of garment 13 incorporating a robotic mechanism, it is intended that the whole of garment 13 be furnished with robotic mechanisms, of the same type or of different types, in an embodiment of the invention, so as to be capable of imparting action to garment 13 and to desired portions or features of garment 13, such as to the leg and arm and upper torso portions of garment 13, etc. FIG. 12 is instructive of teachings concerning providing garment 13 with robotic mechanisms.

Any desired robotic mechanisms can be used with the invention consistent with the teachings provided herein, which are operable so as to impart forcible movement. In this respect, it is to be understood that robotic mechanisms can be any such known mechanical devices capable of being activated by computer 11 so as to impart a forcible impulse or movement to garment so as to cause it to move, to inhibit movement of garment 13, etc. The goal of robotic mechanisms incorporated with garment 13 is to promote movement of a trainee wearing garment 13 in a particular or desired manner consistent with the trainer movement paths of a trainer model. Consistent with this, any such apparatus capable of performing this function can be used with the invention. It is further envisioned that garment 13 be furnished with instruments capable of imparting involuntary muscle movement, in response to actuation by computer 11, to a trainee wearing garment 13 so as to promote involuntary movement to the trainee in a particular or desired manner consistent with the trainer movement paths of a trainer model, such as trainer model 20. In this respect, garment 13 can incorporate devices capable of generating and delivering applied electrical impulses or other form of energy or impulse to a trainee, which are directed to muscle tissue or elsewhere so as to promote involuntary muscle movement designed to promote a particular type of muscle contraction or movement. Applied electrical impulses can be delivered cutaneously, subcutaneously with the use of pins or probes delivered directly into muscle tissue, etc. Other ways of providing involuntary muscle contraction/movement for causing desired movement in a trainee can be used with the invention and will readily occur to those skilled in the art. Anything associated with garment 13 capable of promoting movement to a trainee wearing garment 13 may be considered within the ambit of “robotic mechanism.” It is envisioned that a trainee can wear trainee garment 13 while sleeping, in which applied electrical or other energy pulses are directed at the trainee so as to stimulate involuntary muscle movements in accordance with a selected trainer model running on the computer in, for instance, a continuous feedback loop, as a means for creating muscle memory.

In a particular embodiment, robotic mechanisms 80 are each associated with each of the trainee reference points of garment 13, namely, sensors 15 thereof. In a comparing event carried out by computer 11 as herein described wherein a trainee model is compared to a trainer model, the comparing event is carried out by computer 11 in real time, in which the trainee model is generated in real time as the trainee initiates a selected movement and is compared real time to trainer model 20 maintained by storage 25. This real time comparison can be initiated manually, or, in accordance with programming provided by software 26, automatically by computer in response to a trainee initiating a selected movement. In this embodiment, computer 11 compares the trainer reference movement paths of the trainer reference points of trainer model 20 to the trainee reference movement paths of the trainee reference points of the trainee model during the course of its acquisition. Computer 11 is responsive to this real-time comparison event, and for each trainee reference point activates its corresponding robotic mechanism 80 if the trainee reference movement path thereof does not sufficiently correspond to, or otherwise fall within an acceptable range relating to, the trainer reference movement path of the corresponding trainer reference point of trainer model 20. When robotic mechanism 80 of a particular trainee reference point activates, it imparts forcible movement to garment 13 or inhibits movement of garment 13, otherwise promoting movement of the particular trainee reference movement path for which it corresponds back within its corresponding trainer reference movement path of trainer model 20. This embodiment provides the trainee with immediate promotion of movement maintaining the trainee movement paths to the trainer movement paths of the trainer model 20 during the course of the trainee movement.

The present invention is described above with reference to a preferred embodiment and to preferred teachings. However, those skilled in the art will recognize that changes and modifications may be made to the invention without departing from the nature and scope thereof. For instance, a trainee garment 13 can be provided with an onboard computer for use in storing trainer models and acquiring trainee models and comparing trainee models to trainer models. A trainer garment can also be provided with its own onboard computer for collecting and storing trainer models, if desired. The invention can also be exploited in a networked computer environment, such as local area network or a generalized computer network, such as the Internet, in which stored trainer models are accessed over the computer network for use by user trainees. In a networked environment, trainer models can be maintained by a networked server or other storage device, in which the stored trainer models are accessed by user clients over a privately- or publicly-accessible web site. Also, the invention can incorporate gyroscopes and even satellite data including satellite global positioning data for use in acquiring trainee and trainer models, if desired, and also force platforms for measuring moments along x, y and z axes.

Various changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Apparatus comprising:
storage maintaining a reference body movement model;
a system for collecting a trainee body movement model;
a computer associated with the storage and the system for comparing the trainee body movement model to the reference body movement model and generating a report comparing the trainee body movement model to the reference body movement model.

2. Apparatus of claim 1, wherein the report includes an identification of similarity between the trainee body movement model and the reference body movement model.

3. Apparatus of claim 1, wherein the report includes an identification of dissimilarity between the trainee body movement model and the reference body movement model.

4. Apparatus of claim 1, wherein the report includes remedial instructional information explaining how to correct the trainee body movement model to conform substantially to the reference body movement model.

5. Apparatus comprising:
a first system for collecting a reference body movement model;
a second system for collecting a trainee body movement model;
a computer associated with the first system and the second system for comparing the trainee body movement model to the reference body movement model and generating a report comparing the trainee body movement model to the reference body movement model.

6. Apparatus of claim 5, wherein the report includes an identification of similarity between the trainee body movement model and the reference body movement model.

7. Apparatus of claim 5, wherein the report includes an identification of dissimilarity between the trainee body movement model and the reference body movement model.

8. Apparatus of claim 5, wherein the report includes remedial instructional information explaining how to correct the trainee body movement model to conform substantially to the reference body movement model.

9. Apparatus comprising:
storage maintaining a database of reference body movement models;
a trainee body movement model collection system;
a computer associated with the storage and the trainee body movement model collection system for comparing a trainee body movement model collected by the trainee body movement model collection system to a designated one of the reference body movement models and generating a report comparing the trainee body movement model to the designated one of the reference body movement models.

10. Apparatus of claim 9, wherein the report comparing the trainee body movement model to the designated one of the reference body movement models includes an identification of similarity between the trainee body movement model and the designated one of the reference body movement models.

11. Apparatus of claim 9, wherein the report comparing the trainee body movement model to the designated one of the reference body movement models includes an identification of dissimilarity between the trainee body movement model and the designated one of the reference body movement models.

12. Apparatus of claim 9, wherein the report comparing the trainee body movement model to the designated one of the reference body movement models includes remedial instructional information explaining how to correct the trainee body movement model to conform substantially with the designated one of the reference body movement models.

13. Apparatus comprising:
storage maintaining a database of reference body movement models;
a trainee body movement model collection system;
a computer associated with the storage and the trainee body movement model collection system for comparing a trainee body movement model collected by the trainee body movement model collection system to designated ones of the reference body movement models and generating a report comparing the trainee body movement model to each of the designated ones of the reference body movement models.

14. Apparatus of claim 13, wherein the report comparing the trainee body movement model to each of the designated ones of the reference body movement models includes an identification of similarity between the trainee body movement model and each of the designated ones of the reference body movement models.

15. Apparatus of claim 13, wherein the report comparing the trainee body movement model to each of the designated ones of the reference body movement models includes an identification of dissimilarity between the trainee body movement model and each of the designated ones of the reference body movement models.

16. Apparatus of claim 13, wherein the report comparing the trainee body movement model to each of the designated ones of the reference body movement models includes remedial instructional information explaining how to correct the trainee body movement model to conform substantially with each of the designated ones of the reference body movement models.

17. Apparatus comprising:
storage maintaining a reference body movement model indicative of movement of reference points in space, each of the reference points defining a predetermined reference movement path;
a system for generating a trainee body movement model indicative of movement of trainee reference points in space, each of the trainee reference points defining a trainee movement path corresponding to one of the reference movement paths;
alarms each associated with one of the trainee reference points; and
a computer for comparing the reference movement paths of the reference points of the reference body movement model to the trainee movement paths of the trainee reference points of the trainee body movement model, and for each trainee reference point activating its corresponding alarm if the trainee movement path thereof does not sufficiently correspond to the reference movement path of the corresponding reference point of the reference body movement model.

18. Apparatus of claim 17, wherein the system is carried by a close-fitting garment.

19. Apparatus of claim 18, wherein the alarms are carried by the close-fitting garment each at one of the trainee reference points.

20. Apparatus of claim 17, wherein when activated each of the alarms issues an alerting stimulus.

21. Apparatus of claim 20, wherein the alerting stimulus is at least one of an audible stimulus, a visual stimulus, and a physical stimulus.

22. Apparatus comprising:
storage maintaining a reference body movement model indicative of movement of reference points in space, each of the reference points defining a predetermined reference movement path;
a system for generating a trainee body movement model indicative of movement of trainee reference points in space, each of the trainee reference points defining a trainee movement path corresponding to one of the reference movement paths;
a plurality of robotic mechanisms, carried by a close fitting garment, each associated with one of the trainee reference points; and
a computer for comparing the reference movement paths of the reference points of the reference body movement model to the trainee movement paths of the trainee reference points of the trainee body movement model, and for each trainee reference point activating its corresponding robotic mechanism to promote corrective movement to the close-fitting garment if the trainee movement path thereof does not sufficiently correspond to the reference movement path of the corresponding reference point of the reference body movement model.

23. Apparatus of claim 22, wherein the system is carried by the close-fitting garment.
